(19) United States
(12) Patent Application Publication
(10) Pub. No.: US 2020/0039379 A1
(43) Pub. Date: Feb. 6, 2020

(54) Device To At Least Partial Unload One Electric Energy Storage

(71) Applicant: AB Mikroelektronik Gesellschaft mit beschraenkter Haffung, Salzburg (AT)

(72) Inventor: Andreas Schlosser, Lamprechtshausen (AT)

(21) Appl. No.: 16/504,936

(22) Filed: Jul. 8, 2019

(30) Foreign Application Priority Data
Aug. 1, 2018 (DE) 102018006054.4

(51) Int. Cl. B60L 58/10; H02J 7/00; B60K 6/28; B60L 50/60

(52) U.S. Cl. CPC B60L 58/10; H02J 7/0063; H02J 7/345; B60L 50/60; H02J 2007/0067; B60K 6/28

(57) ABSTRACT

Example aspects relate to a device for at least partially discharging an electrical energy store or an electrical intermediate circuit, comprising a discharge path, which extends between a first junction point and a second junction point and includes a setting device and an adjusting device, wherein the electrical energy store or the electrical intermediate circuit is electrically conductively connectable or connected to the discharge path via the first junction point and the second junction point, wherein, during an occurring, at least partial discharge of the electrical energy store or of the electrical intermediate circuit via the discharge path, a temperature of the setting device changes due to the discharge, and comprising a control device connected to the setting device in a signal-conducting manner, wherein the setting device can be brought into an electrically non-conductive open position and into an electrically conductive closed position, depending on a control signal of the control device, wherein the control signal is dependent on the temperature of the setting device.

### FIELD

The present disclosure relates to a device for at least partially discharging an electrical energy store or an electrical intermediate circuit, an arrangement, a supply network for a vehicle, and a vehicle comprising such a device, as well as a use of such a device for at least partially discharging an electrical energy store or an electrical intermediate circuit.

### BACKGROUND

Devices for discharging an electrical energy store or an electrical intermediate circuit are utilized, for example, in electric vehicles or hybrid vehicles. Electrical consumers, in particular electric drives, which are operated using high voltages are installed in such vehicles. Depending on the power of the electric drive train, voltages, for example, of electrical energy stores (for example, a battery) or electrical intermediate circuits (for example, a capacitor bank) of up to 400 V and more can be provided. Devices for discharging the energy stores are provided as a protective measure against danger to persons.

Publication WO 2009/106188 A1 describes, for example, a discharge circuit for an electrical energy store in the form of a buffer capacitor, which comprises a switchable resistor, with the aid of which the discharge takes place. The resistor is a temperature-dependent resistor (PTC resistor) which heats up during the discharge and, as a result, increases its resistance, whereby the discharge current is reduced. The disadvantage of this concept is that, due to the temperature dependence of the temperature-dependent resistor arranged in the discharge path, a defined discharge current cannot be predetermined and, due to the change of the resistance value during the discharge, the duration of the discharge may not be predicted.

### SUMMARY

Aspects and advantages of embodiments of the present disclosure will be set forth in part in the following description, or may be learned from the description, or may be learned through practice of the embodiments.

Example aspects of the present disclosure provide a device for at least partially discharging an electrical energy store or an electrical intermediate circuit. One example aspect of the present disclosure is directed to a device for at least partially discharging an electrical energy store or an electrical intermediate circuit. The device includes a discharge path which extends between a first junction point and a second junction point and includes a setting device and an adjusting device. The electrical energy store or the electrical intermediate circuit is electrically conductively connectable or connected to the discharge path via the first junction point and the second junction point. During an occurring of at least partial discharge of the electrical energy store or of the electrical intermediate circuit via the discharge path, a temperature of the setting device changes due to the discharge, and comprising a control device connected to the setting device in a signal-conducting manner, wherein the setting device can be brought into an electrically non-conductive open position and into an electrically conductive closed position, depending on a control signal of the control device, characterized in that the control signal is dependent on the temperature of the setting device.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

FIG. 1 shows a schematic representation of an electric car comprising an arrangement including a device according to disclosure example embodiments of the present disclosure;

FIG. 2 shows a detailed representation of the arrangement from FIG. 1,

FIG. 3 shows an exemplary embodiment of a device according to disclosure example embodiments of the present disclosure, and

FIG. 4 shows a further exemplary embodiment of a device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope of the present disclosure. For instance, features illustrated or described as part of one embodiment can be used with another embodiment to yield a still further embodiment. Thus, it is intended that aspects of the present disclosure cover such modifications and variations.

A problem addressed by the disclosure is that of avoiding the above-described disadvantages and providing a device for discharging an electrical energy store or an electrical intermediate circuit, which is improved with respect to the prior art. In particular, it can be possible to better predetermine and reduce the duration of the discharge. In addition, the thermal load on the setting device can be taken into account in order to protect the setting device against thermal damage, which can occur during the discharge of the electric energy store or the electric intermediate circuit.

This problem can be solved by a device having the features according to example aspects of the present disclosure, an arrangement, a supply network for a vehicle, and a vehicle comprising such a device, and by a use having the features according to example aspects of the present disclosure.

With respect to the disclosure, it is provided that the control signal can be dependent on the temperature of the setting device.

As a result, the thermal load of the setting device can be taken into account in that the discharge can be interrupted with the aid of an appropriate control signal, which can be dependent on the temperature of the setting device, in order to prevent thermal damage to the setting device. As a result, a discharge with the maximum discharge current can also take place for as long as it takes for a definable limiting value for the temperature of the setting device to be reached, whereby a preferably efficient discharge can take place, the discharge duration of which is reduced.

In addition, changed thermal properties of the components arranged in the discharge path do not directly affect the operating parameters of the discharge path. Instead, these influences are limited to the control signal for the setting device.

A discharge of the electrical energy store or of the electrical intermediate circuit via the discharge path can take place when the setting device is in an electrically conductive closed position.

During a discharge, energy of the electrical energy store or of the electrical intermediate circuit can be taken up by the setting device and the adjusting device and, for example, can be converted into thermal energy. A discharge current flows, which can result in a conversion into thermal energy not only in the adjusting device, but also in the setting device, whereby the setting device heats up and, as a result, the temperature of the setting device can increase.

Due to the temperature change of the setting device, the control signal can also change, so that, for example, at an elevated temperature of the setting device, the correspondingly changed control signal can result in the setting device being brought into an electrically non-conductive open position.

An electrically non-conductive open position of the setting device can be understood to be a switching state in which a discharge of the electrical energy store or of the electrical intermediate circuit via the discharge path essentially cannot take place.

When the discharge stops and, as a result, the setting device cools down again, the control signal, which has therefore correspondingly changed, can result in the setting device being brought into an electrically conductive closed position.

An electrically conductive closed position of the setting device can be understood to be a switching state in which a discharge of the electrical energy store or of the electrical intermediate circuit via the discharge path can take place.

The setting device can have precisely one open position and one closed position. The setting device can also have a plurality of closed positions which differ, for example, with respect to the level of the electric current which can flow through the setting device. A closed position can also be provided, in which the level of the current, which can flow through the setting device, can be adjustable with the aid of an amplitude and/or frequency of the control signal.

Moreover, the duration of the desired complete or partial discharge can be set with the aid of an appropriate design of the adjusting device (for example, an appropriate dimensioning of an adjusting device in the form of an ohmic resistance and/or an inductor).

It can be provided that a shutoff temperature is predefinable, wherein the setting device can be brought into the open position with the aid of the control signal when the shutoff temperature is reached. When the setting device has become heated, due to the discharge of the electrical energy store or the electrical intermediate circuit, to such an extent that the predefinable shutoff temperature is reached or exceeded, the setting device can be switched into the electrically non-conductive open position with the aid of the control signal. As a result, the setting device can be protected against thermal overload. It can also be provided that the setting device can be brought into a closed position with the aid of the control signal when the predefinable shutoff temperature has been fallen below. An appropriate hysteresis can be provided in order to avoid overly frequent position changes of the setting device in the range of the shutoff temperature.

According to an example, it can be provided that the adjusting device can essentially be an ohmic resistance. During a discharge, electrical energy of the electrical energy store or of the electrical intermediate circuit can be converted into thermal energy. The adjusting device can also be present, however, for example, in the form of an inductor or can comprise an inductor.

It can be provided that the setting device and the adjusting device are connected in series in the discharge path. Due to a series connection, the same discharge current flows in the discharge path both through the setting device and the adjusting device.

In some embodiments, it can be provided that the setting device comprises a control terminal, wherein the control terminal can be connected to the control device in a signal-conducting manner in order to receive the control signal. In other words, the control signal can be conducted from the control device via a signal line to the control terminal of the setting device. A buffer circuit and/or an amplifier circuit for amplifying the control signal can also be arranged in the signal line.

According to an example embodiment, it can be provided that the setting device comprises a transistor, possibly a field-effect transistor, specifically a metal-oxide-semiconductor field-effect transistor, wherein the control signal can be a control voltage, wherein the control voltage can be present at the control terminal of the transistor. The setting device can be voltage-controlled in this case. In the case of a bipolar transistor, the control terminal can be also referred to as the “base”. In the case of a field-effect transistor, the control terminal can be usually referred to as the “gate”. A field-effect transistor can have two further terminals, which are referred to as “drain” and “source”. When a field-effect transistor is utilized in the setting device, these two terminals can be located in the discharge path, wherein an electrical connection from drain to source may not exist in an open position of the setting device and an electrical connection from drain to source can be established in a closed position of the setting device. Metal-oxide-semiconductor field-effect transistors, which are also referred to as MOSFETs, are frequently utilized as field-effect transistors.

It can be provided that the device comprises a temperature sensor, wherein the temperature sensor can be arranged in or on the setting device, wherein the temperature sensor can ascertain the temperature of the setting device and can signal the temperature to the control device. The control device can therefore adapt the control signal depending on the transmitted temperature. The temperature sensor can be arranged, for example, on the housing of the setting device. The temperature sensor can be a semiconductor temperature sensor comprising a voltage outlet, wherein a voltage dependent on the measured temperature can be made available via the voltage outlet.

According to an example, it can be provided that the control device comprises at least one temperature-dependent component, wherein the at least one temperature-dependent component can be thermally coupled to the setting device, possibly in a thermally conductive manner, whereby the temperature of the setting device can be transmitted to the at least one temperature-dependent component, wherein the control signal is dependent on the temperature of the at least one temperature-dependent component. The at least one temperature-dependent component can be a temperature-dependent resistor. A semiconductor sensor or a thermocouple, for example, can also be utilized as the temperature-dependent component. Due to the thermal coupling, heat, which arises due to a discharge in the setting device, is given off to the temperature-dependent component, and so the temperature-dependent component assumes the temperature of the setting device. The temperature-dependent component can be adhered to the setting device, for example, with the aid of a thermally conductive adhesive, or can be soldered on the setting device.

It can be provided that the at least one temperature-dependent component can be a temperature-dependent resistor. It can be a positive temperature coefficient resistor (PTC resistor). It is also possible, however, that a negative temperature coefficient resistor (NTC resistor) can be utilized as the temperature-dependent resistor.

In some embodiments, it can be provided that the control device comprises a first voltage divider including two series-connected resistors, wherein one of the two resistors can be the temperature-dependent resistor, wherein the control voltage can be dependent on the dominant voltage between the two resistors. In other words, the control voltage can be dependent on the output voltage of the first voltage divider in this case. Of the two resistors, the one that is not the temperature-dependent resistor can be variable, whereby the shutoff temperature of the setting device can be set via the selection of the resistance value of the variable resistor.

It can be provided that the control voltage can be proportional or equal to the dominant voltage between the two series-connected resistors. In this case, the control voltage precisely corresponds to the output voltage of the first voltage divider or can be proportional to the output voltage of the first voltage divider.

According to an example, it can be provided that the control voltage can be dependent on a difference between a predefinable reference voltage and the dominant voltage between the two series-connected resistors.

It can be provided that the control device comprises a comparator including a first voltage input and a second voltage input and comprises a voltage output, wherein the voltage output can be connected to the control terminal of the transistor, wherein the dominant voltage between the two series-connected resistors can be present at the first voltage input of the comparator, wherein the predefinable reference voltage can be present at the second voltage input of the comparator. A comparator is an electronic circuit known per se, which compares two voltages, wherein the output (for example, in binary or digital form) indicates which of the two input voltages is higher. In this case, the output voltage of the first voltage divider can therefore be compared to a predefinable reference voltage, which can represent the shutoff temperature of the setting device. If the temperature-dependent output voltage of the first voltage divider is higher than the predefinable reference voltage (and, therefore, the temperature of the setting device is higher than the shutoff temperature), the setting device can be brought into an open position—given an appropriate wiring of the comparator—with the aid of the signal-conducting connection between the voltage output of the comparator and the control terminal of the transistor, in the case of which the discharge of the electrical energy store or of the electrical intermediate circuit can be stopped via the discharge path, whereby the setting device can cool down again and no thermal damage to the setting device occurs.

It can be provided that the control device comprises a second voltage divider, which can be connected in parallel to the first voltage divider and can include two series-connected reference resistors, wherein the dominant voltage between the two series-connected reference resistors can be the reference voltage. One of the two reference resistors or both reference resistors can be variable, whereby the reference voltage and, therefore, the shutoff temperature of the setting device can be adjusted.

It can be provided that a, switchable, DC voltage can be present on an input side of the first voltage divider, wherein the DC voltage can be adjustable.

It can be provided that the control device comprises a stabilizing circuit, possibly in the form of a shunt regulator or a series regulator, wherein the DC voltage can be made available via the stabilizing circuit.

In some embodiments, it can be provided that the stabilizing circuit comprises a stabilizing resistor and a Zener diode connected thereto in series, wherein the dominant voltage between the stabilizing resistor and the Zener diode can be the DC voltage present on the input side of the first voltage divider. In other words, the output voltage of the stabilizing circuit, which drops across the Zener diode, can be present on the input side of the first voltage divider.

It can be provided that the control device comprises a bypass circuit, wherein the Zener diode can be bypassed with the aid of the bypass circuit. Due to a bypassing of the Zener diode, the voltage between the stabilizing resistor and the Zener diode can be connected to ground. As a result, the input voltage of the first voltage divider can also be essentially 0V, whereby the output voltage of the first voltage divider can also be essentially 0V.

It can be provided that the bypass circuit comprises a bypass transistor, wherein the bypass transistor can be connected in parallel to the Zener diode. An optical coupler or a relay, for example, can also be utilized in the bypass circuit.

Protection is also sought for an arrangement comprising a device according to the disclosure and an electrical energy store or an electrical intermediate circuit according to example aspects of the present disclosure. In this case, the electrical energy store or the electrical intermediate circuit comprises a first pole and a second pole, wherein the first pole can be electrically conductively connected to the first junction point of the device and the second pole can be electrically conductively connected to the second junction point of the device. In other words, the electrical energy store or the electrical intermediate circuit can therefore be connected in parallel to the discharge path.

Protection is also sought for a supply network for a vehicle comprising an arrangement according to the disclosure and for a vehicle comprising such a supply network. The vehicle can possibly be an electric vehicle or a hybrid vehicle.

Protection is also sought for a use of a device according to according to example aspects of the present disclosure. In this case, the device can be utilized for at least partially discharging an electrical energy store or an electrical intermediate circuit, wherein a first pole of the electrical energy store or of the electrical intermediate circuit can or can become electrically conductively connected to the first junction point of the device and a second pole of the electrical energy store or of the electrical intermediate circuit can or can become electrically conductively connected to the second junction point of the device.

Further details and advantages of the present disclosure are explained with reference to the following description of the figures.

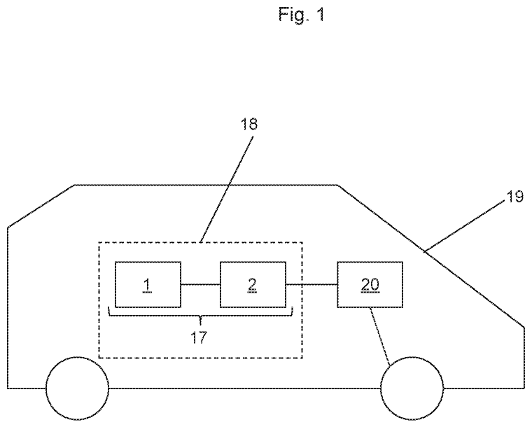

FIG. 1 shows a schematic representation of a vehicle 19 in the form of an electric car comprising a supply network 18, which includes an arrangement 17 encompassing an electrical energy store 2 as well as a device 1 according to the disclosure for at least partially discharging the electrical energy store 2. In this example, the supply network 18 supplies a consumer 20 in the form of an electric drive with electrical energy from the electrical energy store 2.

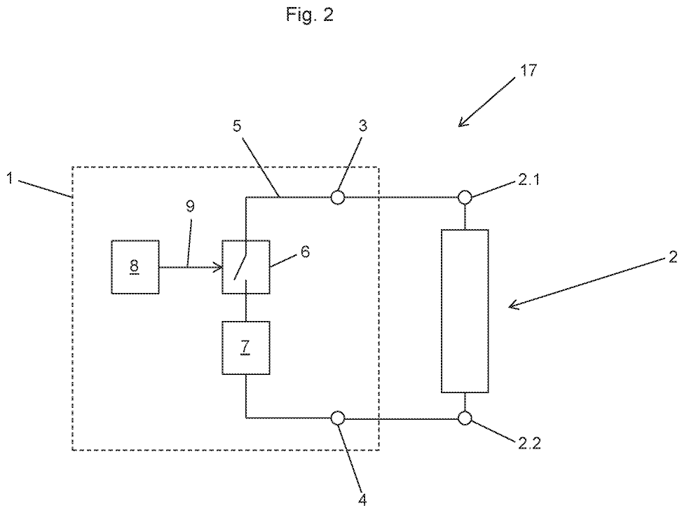

FIG. 2 shows a detailed representation of the arrangement 17 from FIG. 1. The device 1 comprises a first junction point 3 and a second junction point 4. The electrical energy store 2 comprises a first pole 2.1 and a second pole 2.2, wherein the first pole 2.1 is electrically conductively connected to the first junction point 3 of the device 1 and the second pole 2.2 is electrically conductively connected to the second junction point 4 of the device 1.

A discharge path 5, in which a setting device 6 and an adjusting device 7 are arranged in a series-connected manner, extends between the first junction point 3 and the second junction point 4. The junction points 3, 4 can be designed as terminals to which the poles 2.1, 2.2, respectively, of the electrical energy store 2 are to be connected. It is also possible, however, that the electric lines or strip conductors, which connect the setting device 6 and the adjusting device 7 to the electrical energy store 2, represent the junction points 3, 4 of the device 1.

The device 1 comprises a control device 8, which is connected to the setting device 6 in a signal-conducting manner and provides a control signal 9 for the setting device 6. Depending on the control signal 9 of the control device 8, the setting device 6 can be brought into an electrically non-conductive open position and into an electrically conductive closed position. When the setting device 6 is in an electrically non-conductive open position, a discharge of the electrical energy store 2 via the discharge path 5 cannot take place. When the setting device 6 is in an electrically conductive closed position, a discharge of the electrical energy store 2 via the discharge path 5 can take place. In the representation shown, the setting device 6 is in an electrically non-conductive open position and a discharge of the electrical energy store 2 via the discharge path 5 cannot take place.

When the setting device 6 is in an electrically conductive closed position and a discharge of the electrical energy store 2 via the discharge path 5 can take place, a discharge current flows along the discharge path 5, which results in a conversion into thermal energy in the setting device 6 and in the adjusting device 7, whereby the setting device 6 heats up and, as a result, a temperature of the setting device 6 increases.

As a safety measure against thermal damage to the setting device 6, the control signal 9 is now dependent on the temperature of the setting device 6. As a result, the setting device 6 can be brought into an electrically non-conductive open position even before damage occurs to the setting device 6 due to the thermal overload situation.

In the example shown, a shutoff temperature is predefined, wherein the setting device 6 is brought into the open position with the aid of the control signal 9 when the shutoff temperature is reached. As a result, the discharge stops and the setting device 6 can cool down again.

The temperature dependence of the control signal 9 can be achieved, for example, in that a temperature sensor ascertains the temperature of the setting device 6 (for example, on the housing) and signals the temperature to the control device 8, whereupon the control device 8 adapts the control signal 9 depending on the transmitted temperature. The control device 8 can also comprise a temperature-dependent component, however, which is thermally coupled to the setting device 6, for example, in that the temperature-dependent component is mounted on the setting device 6 with the aid of a thermally conductive adhesive. Due to the direct thermal coupling, a temperature change of the setting device 6 can directly affect the control signal 9 of the control device 8.

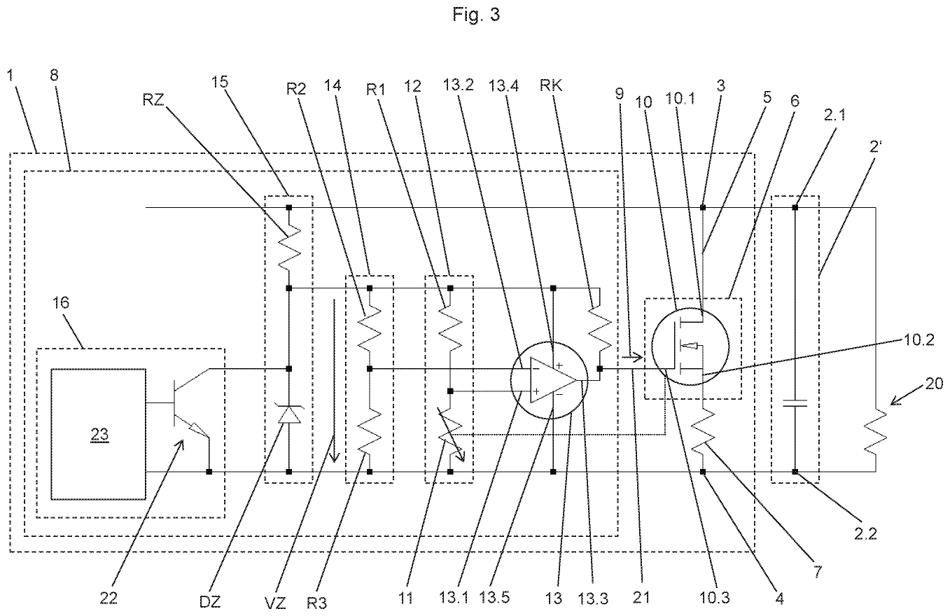

FIG. 3 shows an embodiment of a device 1, which is connected via junction points 3, 4 to an electrical intermediate circuit 2′ (in this example, in the form of a capacitor bank) or its poles 2.1, 2.2. The electrical intermediate circuit 2′ supplies a consumer 20, which is connected to the poles 2.1, 2.2 of the electrical intermediate circuit 2′. The first pole 2.1 represents a positive voltage connection of the electrical intermediate circuit 2′ and the second pole 2.2 represents a negative voltage connection of the electrical intermediate circuit 2′. The second pole 2.2 represents the common ground for the device 1 and, therefore, also for the control device 8 contained in the device 1. In the example shown, the consumer 20 is an ohmic resistance. The consumer 20 could also be an impedance, in principle.

A discharge path 5 extends between the junction points 3, 4, in which, starting from the positive voltage level of the electrical intermediate circuit 2′ at the junction point 3, a setting device 6 comprising a transistor 10 in the form of a metal-oxide-semiconductor field-effect transistor (MOSFET) and an adjusting device 7 in the form of an ohmic resistance are connected in series. The adjusting device 7 is connected to the common ground at the junction point 4. The transistor 10 comprises a first transistor terminal 10.1 (drain terminal of the MOSFET), a second transistor terminal 10.2 (source terminal of the MOSFET) and a control terminal 10.3 (gate terminal of the MOSFET). The first transistor terminal 10.1 is connected to the first junction point 3 and the second transistor terminal 10.2 is connected to the adjusting device 7. The transistor 10 utilized here is a self-locking MOSFET, i.e., when the voltage present at the control terminal 10.3 is less than a threshold voltage that is characteristic for the transistor 10, the transistor 10 is in an electrically non-conductive open position in which a current flow from the first transistor terminal 10.1 to the second transistor terminal 10.2 is prevented. Only when the voltage present at the control terminal 10.3 is equal to or greater than the characteristic threshold voltage is the transistor 10 in an electrically conductive closed position in which a current flow from the first transistor terminal 10.1 to the second transistor terminal 10.2 is possible.

The device 1 comprises a control device 8, which is connected in a signal-conducting manner, via a control line 21, to the control terminal 10.3 of the transistor 10 of the setting device 6.

The control device 8 contains a first voltage divider 12 comprising two components, one of which is a temperature-dependent component. Specifically, the first voltage divider 12, which is shown, comprises two series-connected resistors R1, 11. One of the two resistors R1, 11 is a temperature-dependent resistor 11, which is thermally coupled to the setting device 6, i.e., to the transistor 10 in the embodiment shown. This thermal coupling is indicated by a dotted line between the setting device 6 and the temperature-dependent resistor 11. In the example shown, the temperature-dependent resistor 11 is a negative temperature coefficient resistor (NTC resistor), which is mounted on the setting device 6 with the aid of a thermally conductive adhesive and, in this way, is thermally conductively connected to the setting device 6. On the input side, a DC voltage VZ is present at the first voltage divider 12 and is made available by a stabilizing circuit 15 comprising a stabilizing resistor RZ and a Zener diode DZ connected thereto in series. The stabilizing circuit 15 is connected in parallel to the junction points 3, 4, so that the voltage made available by the electrical intermediate circuit 2′ also forms the input voltage of the stabilizing circuit 15. The dominant voltage between the stabilizing resistor RZ and the Zener diode DZ or the voltage dropping across the Zener diode DZ to the common ground at the junction point 4 is the output-side DC voltage VZ of the stabilizing circuit 15, which is present on the input side of the first voltage divider 12.

The control device 8 also comprises a comparator 13, the positive supply terminal 13.4 and negative supply terminal 13.5 of which are connected in parallel to the DC voltage VZ. The comparator 13 comprises a first voltage input 13.1, a second voltage input 13.2, and a voltage output 13.3, which is connected via a comparator resistor RK to the positive voltage connection 13.4 of the comparator 13. The function of the comparator resistor RK is identical to that of a pull-up resistor. The voltage output 13.3 of the comparator 13 is connected in a signal-conducting manner, via the control line 21, to the control terminal 10.3 of the transistor 10. The voltage output 13.3 of the comparator 13 therefore delivers the control signal 9 in the form of a control voltage.

The output voltage of the first voltage divider 12 is present at the first voltage input 13.1 of the comparator 13, i.e., the dominant voltage between the two series-connected resistors 11, R1 of the first voltage divider 12. Specifically, in the example shown, the voltage dropping across the temperature-dependent resistor 11 to the common ground at the junction point 4 is present at the first voltage input 13.1.

The output voltage of a second voltage divider 14, which is connected in parallel to the DC voltage VZ on the input side, is present at the second voltage input 13.2 of the comparator 13. The second voltage divider 14 comprises two series-connected reference resistors R2, R3. The dominant voltage between the two series-connected reference resistors R2, R3 is present at the second voltage input 13.2. Specifically, in the example shown, the voltage dropping across the reference resistor R3 to the common ground at the junction point 4 is present at the second voltage input 13.2.

The output voltage of the second voltage divider 14, which is present as the reference voltage at the second voltage input 13.2 of the comparator 13 and is compared, by the comparator 13, to the output voltage of the first voltage divider 12, can be set by way of the selection of the resistance values for the reference resistors R2, R3. Due to the thermal coupling of the temperature-dependent resistor 11 to the setting device 6, the output voltage of the first voltage divider 12 is dependent on the temperature of the setting device 6. When the temperature of the setting device 6 increases due to an occurring discharge of the electrical intermediate circuit 2′, the resistance value of the temperature-dependent resistor 11 designed as an NTC resistor reduces and the voltage present at the first voltage input 13.1 reduces. When this voltage present at the first voltage input 13.1 falls below the reference voltage of the second voltage divider 14 present at the second voltage input 13.2 due to a temperature increase of the setting device 6, the voltage output 13.3 of the comparator 13 delivers an appropriate control voltage for the control terminal 10.3 of the transistor 10 in order to bring the control terminal 10.3 into an electrically non-conductive open position in which a current flow from the first transistor terminal 10.1 to the second transistor terminal 10.2 is prevented. In the example shown, in this case, the control voltage would be essentially lowered to the potential at the negative supply terminal 13.5 of the comparator 13 and would be essentially 0V and, therefore, below the threshold voltage of the transistor 10 designed as a self-locking MOSFET. As a result, the transistor 10 transitions into its self-locking normal position, which is an electrically non-conductive open position in which a current flow from the first transistor terminal 10.1 to the second transistor terminal 10.2 is prevented. Due to the prevention of the current flow, the transistor 10 can cool down, whereby the resistance value of the temperature-dependent resistor 11 increases. As a result, the voltage present at the first voltage input 13.1 also increases. When this voltage present at the first voltage input 13.1 exceeds the reference voltage of the second voltage divider 14 present at the second voltage input 13.2 due to a temperature decrease of the setting device 6, the voltage output 13.3 of the comparator 13 delivers an appropriate control voltage for the control terminal 10.3 of the transistor 10 in order to bring the control terminal 10.3 into an electrically conductive closed position in which a current flow from the first transistor terminal 10.1 to the second transistor terminal 10.2 is possible and a discharge of the electrical intermediate circuit 2′ can take place. In the example shown, in this case, the control voltage would be raised to the potential at the positive supply terminal 13.4 of the comparator 13 (essentially corresponds to the DC voltage VZ), which is higher than the threshold voltage of the transistor 10 designed as a self-locking MOSFET, whereby the transistor 10 is brought into an electrically conductive closed position.

The comparator 13 therefore functions in connection with the first voltage divider 12, the second voltage divider 14, and the stabilizing circuit 15 as a safety circuit for the setting device 6, in order to prevent thermal damage to the setting device 6, which could occur during the discharge of the electrical intermediate circuit 2′.

In order to activate or deactivate, in principle, a discharge of the electrical intermediate circuit 2′, the control device 8 comprises a bypass circuit 16, with the aid of which the Zener diode DZ can be bypassed. In the example shown, the bypass circuit 16 comprises a bypass transistor 22, which is connected in parallel to the Zener diode DZ. The bypass transistor 22 can be activated by a transistor driver 23, which is known per se. When the bypass transistor 22 is brought into an electrically conductive switch position by the transistor driver 23, the zener diode DZ is bypassed and the DC voltage VZ decreases essentially to the voltage level of the common ground at the junction point 4 (essentially 0V). As a result, the control voltage is also essentially 0V and, therefore, is below the threshold voltage of the transistor 10 designed as a self-locking MOSFET. The transistor 10 is in its self-locking normal position, which is an electrically non-conductive open position in which a current flow from the first transistor terminal 10.1 to the second transistor terminal 10.2 is prevented. A discharge of the electrical intermediate circuit 2′ via the discharge path 5 is therefore not possible.

When the bypass transistor 22 is brought into an electrically non-conductive switch position by the transistor driver 23, the Zener diode DZ is not bypassed and makes the DC voltage VZ available for the safety circuit, as described above. The discharge of the electrical intermediate circuit 2′ via the discharge path 5 is therefore possible, in principle, and takes place depending on the temperature of the setting device 6.

In the embodiment shown, the setting device 6 and the adjusting device 7 are connected in series starting from the positive voltage level of the electrical intermediate circuit 2′ at the junction point 3, wherein the adjusting device 7, in the form of an ohmic resistance, is connected to the common ground at the junction point 4. The control voltage at the control terminal 10.3 of the transistor 10 of the setting device 6 is therefore also present across the adjusting device 7. As a result, a regulation of the discharge current in the discharge path 5 is made possible. When the discharge current increases, the voltage dropping across the adjusting device 7 increases, whereby the voltage between the control terminal 10.3 (gate terminal) and the second transistor terminal 10.2 (source terminal) decreases. As a result, the discharge current is throttled. Likewise, the discharge current through the transistor 10 increases when the voltage dropping across the adjusting device 7 decreases due to a reduced discharge current. It is also possible, in principle, however, that the positions of the setting device 6 and the adjusting device 7 in the discharge path 5 are switched. In this case, a regulation of the discharge current could take place via the control voltage at the control terminal 10.3 of the transistor 10.

Unlike that shown in FIG. 3, instead of an NTC resistor, a PTC resistor can also be utilized as a temperature-dependent resistor 11, wherein the wiring of the comparator 13 is to be adapted in such a way that an increase of the temperature of the setting device 6 above a reference temperature predefinable with the aid of the second voltage divider 14 therefore results in the control signal 9, in the form of the control voltage, dropping below the threshold voltage of the transistor 10, whereby the transistor 10 transitions into its self-locking normal position in which a discharge of the electrical intermediate circuit 2′ via the discharge path 5 is prevented.

In addition, unlike that shown in FIG. 3, instead of a self-locking transistor, a self-conducting transistor can be utilized. In this case as well, the circuit would need to be adapted accordingly, so that an increase of the temperature of the setting device 6 above a reference temperature predefinable with the aid of the second voltage divider 14 results in the control signal 9, in the form of the control voltage, rising above the threshold voltage of the transistor 10, whereby the transistor 10, starting from its self-conducting normal position, transitions into an electrically non-conductive open position in which a discharge of the electrical intermediate circuit 2′ via the discharge path 5 is prevented.

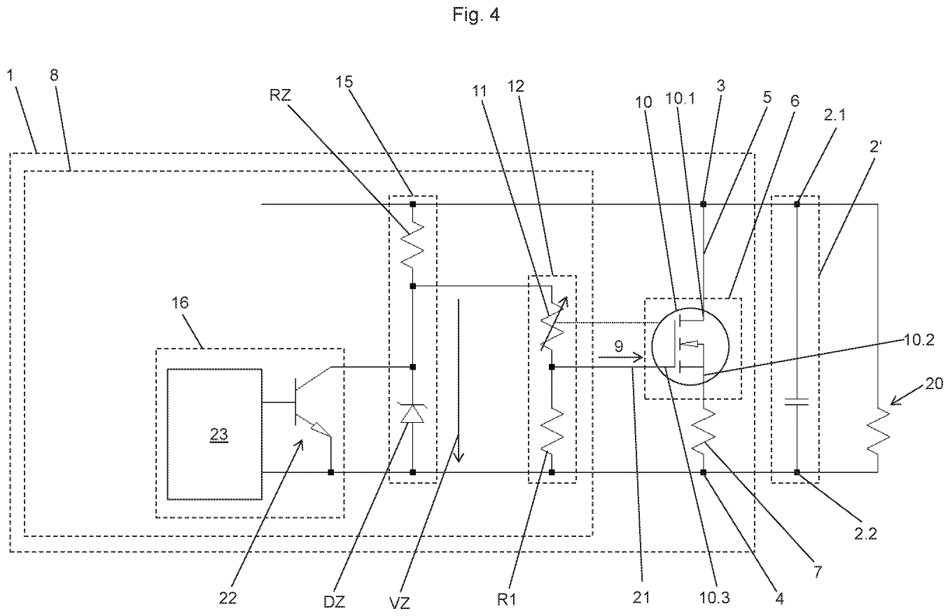

FIG. 4 shows a further embodiment of a device 1. In contrast to the embodiment variant according to FIG. 3, in this example, the control device 8 comprises neither a comparator 13 nor a second voltage divider 14.

The first voltage divider 12 comprises two components, one of which is a temperature-dependent component. Specifically, the first voltage divider 12 shown comprises two series-connected resistors 11, R1. One of the two resistors 11, R1 is a temperature-dependent resistor 11 which is thermally coupled to the setting device 6. This thermal coupling is indicated by a dotted line between the setting device 6 and the temperature-dependent resistor 11.

In the example shown, the temperature-dependent resistor 11 is a positive temperature coefficient resistor (PTC resistor), which is mounted on the setting device 6 with the aid of a thermally conductive adhesive and, in this way, is thermally conductively connected to the setting device 6. On the input side, a DC voltage VZ is present at the first voltage divider 12, which is made available by a stabilizing circuit 15 comprising a stabilizing resistor RZ and a Zener diode DZ connected thereto in series. The stabilizing circuit 15 is connected in parallel to the junction points 3, 4, so that the voltage made available by the electrical intermediate circuit 2′ also forms the input voltage of the stabilizing circuit 15. The dominant voltage between the stabilizing resistor RZ and the Zener diode DZ or the voltage dropping across the Zener diode DZ is the output-side DC voltage VZ of the stabilizing circuit 15, which is present on the input side at the first voltage divider 12.

The output voltage of the first voltage divider 12 (voltage between the temperature-dependent resistor 11 and the resistor R1), which, in the example shown, is the voltage dropping across the resistor R1, is made available, via a control line 21, to the control terminal 10.3 of the transistor 10 as a control signal 9 in the form of a control voltage.

In the case of the discharge possibility of the electrical intermediate circuit 2′ via the discharge path 5, which is activated, in principle, with the aid of the bypass circuit 16, the mode of operation of the control device 8 is as follows.

The first voltage divider 12 is designed, with respect to a low temperature of the setting device 6, for example, an ambient temperature of approximately 25° C., in such a way that the control voltage is greater than the threshold voltage of the transistor 10 designed as a self-locking MOSFET, whereby the transistor 10 is brought into an electrically conductive closed position and a discharge of the electrical intermediate circuit 2′ via the discharge path 5 can take place.

When the setting device 6 heats up due to the occurring discharge, the resistance value of the temperature-dependent resistor 11 thermally coupled to the setting device 6 increases, whereby the control voltage decreases. When the temperature of the setting device 6 reaches a level at which the control voltage drops below the threshold voltage of the transistor 10 due to the correspondingly increased resistance value of the temperature-dependent resistor 11, the transistor 10 transitions into its self-locking normal position, which is an electrically non-conductive open position in which a current flow from the first transistor terminal 10.1 to the second transistor terminal 10.2 is prevented and a discharge of the electrical intermediate circuit 2′ via the discharge path 5 is likewise prevented. As a result, thermal damage to the setting device 6 can be prevented and the setting device 6 can cool down again. When the setting device 6 has cooled down to the point at which the control voltage rises above the threshold voltage of the transistor 10, due to the correspondingly reduced resistance value of the temperature-dependent resistor 11, the transistor 10 is brought into an electrically conductive closed position again and the discharge of the electrical intermediate circuit 2′ via the discharge path 5 can be continued. The shutoff temperature of the setting device 6 can be established via a suitable dimensioning of the resistance values of the resistors 11, R1 of the first voltage divider 12.

Unlike that shown in FIG. 4, instead of a PTC resistor, an NTC resistor can also be utilized as the temperature-dependent resistor 11. In this case, the positions of the temperature-dependent resistor 11 and of the resistor R1 within the first voltage divider 12 would need to be switched. Then, in turn, an increase of the temperature of the setting device 6 above a reference temperature predefinable with the aid of the first voltage divider 12 would result in the control signal 9, in the form of the control voltage, dropping below the threshold voltage of the transistor 10, whereby the transistor 10 transitions into its self-locking normal position in which a discharge of the electrical intermediate circuit 2′ via the discharge path 5 is prevented.

In addition, unlike that shown in FIG. 4, instead of a self-locking transistor, a self-conducting transistor can be utilized. In this case as well, the circuit would need to be adapted accordingly, so that an increase of the temperature of the setting device 6 above a reference temperature predefinable with the aid of the first voltage divider 12 results in the control signal 9, in the form of the control voltage, rising above the threshold voltage of the transistor 10, whereby the transistor 10, starting from its self-conducting normal position, transitions into an electrically non-conductive open position in which a discharge of the electrical intermediate circuit 2′ via the discharge path 5 is prevented.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A device for at least partially discharging an electrical energy store or an electrical intermediate circuit, comprising a discharge path which extends between a first junction point and a second junction point and includes a setting device and an adjusting device, wherein the electrical energy store or the electrical intermediate circuit is electrically conductively connectable or connected to the discharge path via the first junction point and the second junction point, wherein, during an occurring, at least partial discharge of the electrical energy store or of the electrical intermediate circuit via the discharge path, a temperature of the setting device changes due to the discharge, and comprising a control device connected to the setting device in a signal-conducting manner, wherein the setting device can be brought into an electrically non-conductive open position and into an electrically conductive closed position, depending on a control signal of the control device, characterized in that the control signal is dependent on the temperature of the setting device.

2. The device as claimed in claim 1, characterized in that a shutoff temperature is predefinable, wherein the setting device can be brought into the open position with the aid of the control signal when the shutoff temperature is reached.

3. The device as claimed in claim 1, characterized in that the adjusting device is essentially an ohmic resistance.

4. The device as claimed in claim 1, characterized in that the setting device and the adjusting device are connected in series in the discharge path.

5. The device as claimed in claim 1, characterized in that the setting device comprises a control terminal, wherein the control terminal is connected to the control device in a signal-conducting manner in order to receive the control signal.

6. The device as claimed in claim 5, characterized in that the setting device comprises a transistor, preferably a field-effect transistor, particularly preferably a metal-oxide-semiconductor field-effect transistor, wherein the control signal is a control voltage, wherein the control voltage is present at the control terminal of the transistor.

7. The device as claimed in claim 1, characterized in that the device comprises a temperature sensor, wherein the temperature sensor is arranged in or on the setting device, wherein the temperature sensor ascertains the temperature of the setting device and signals the temperature to the control device.

8. The device as claimed in claim 1, characterized in that the control device comprises at least one temperature-dependent component, wherein the at least one temperature-dependent component is thermally coupled to the setting device, preferably in a thermally conductive manner, whereby the temperature of the setting device can be transmitted to the at least one temperature-dependent component, wherein the control signal is dependent on the temperature of the at least one temperature-dependent component.

9. The device as claimed in claim 8, characterized in that the at least one temperature-dependent component is a temperature-dependent resistor.

10. The device as claimed in claim 9, characterized in that the control device comprises a first voltage divider including two series-connected resistors, wherein one of the two resistors is the temperature-dependent resistor, wherein the control voltage is dependent on the dominant voltage between the two resistors.

11. The device as claimed in claim 10, characterized in that the control voltage is proportional or equal to the dominant voltage between the two series-connected resistors.

12. The device as claimed in claim 10, characterized in that the control voltage is dependent on a difference between a predefinable reference voltage and the dominant voltage between the two series-connected resistors.

13. The device as claimed in claim 12, characterized in that the control device comprises a comparator including a first voltage input and a second voltage input, and comprises a voltage output, wherein the voltage output is connected to the control terminal of the transistor wherein the dominant voltage between the two series-connected resistors is present at the first voltage input of the comparator, wherein the predefinable reference voltage is present at the second voltage input of the comparator.

14. The device as claimed in claim 13, characterized in that the control device comprises a second voltage divider, which is preferably connected in parallel to the first voltage divider and includes two series-connected reference resistors, wherein the dominant voltage between the two series-connected reference resistors is the reference voltage.

15. The device as claimed in claim 10, characterized in that a, preferably switchable, DC voltage is present on an input side of the first voltage divider, wherein, preferably, the DC voltage is adjustable.

16. The device as claimed in claim 15, characterized in that the control device comprises a stabilizing circuit, preferably in the form of a shunt regulator or a series regulator, wherein the DC voltage can be made available via the stabilizing circuit.

17. The device as claimed in claim 16, characterized in that the stabilizing circuit comprises a stabilizing resistor and a Zener diode connected thereto in series, wherein the dominant voltage between the stabilizing resistor and the Zener diode is the DC voltage present on the input side of the first voltage divider.

18. The device as claimed in claim 17, characterized in that the control device comprises a bypass circuit, wherein the Zener diode can be bypassed with the aid of the bypass circuit.

19. The device as claimed in claim 18, characterized in that the bypass circuit comprises a bypass transistor, wherein the bypass transistor is connected in parallel to the Zener diode.

20. An arrangement comprising a device as claimed in claim 1, and an electrical energy store or an electrical intermediate circuit, wherein a first pole of the electrical energy store or of the electrical intermediate circuit is electrically conductively connected to the first junction point of the device, and a second pole of the electrical energy store or of the electrical intermediate circuit is electrically conductively connected to the second junction point of the device.

21. A supply network for a vehicle, in particular an electric vehicle or a hybrid vehicle, comprising an arrangement as claimed in claim 20.

22. A vehicle, in particular an electric vehicle or a hybrid vehicle, comprising a supply network as claimed in claim 21.

23. The use of a device as claimed in claim 1 for at least partially discharging an electrical energy store or an electrical intermediate circuit, wherein a first pole of the electrical energy store or of the electrical intermediate circuit is or becomes electrically conductively connected to the first junction point of the device, and a second pole of the electrical energy store or of the electrical intermediate circuit is or becomes electrically conductively connected to the second junction point of the device.
